(19) United States
(12) Patent Application Publication
(10) Pub. No.: US 2006/0009562 A1
(43) Pub. Date: Jan. 12, 2006

(54) Cationically polymerizable composition containing metal oxide partricles

(76) Inventor: Hiroshi Sasaki, Nagoya-shi (JP)

Correspondence Address: SUGHRUE MION, PLLC, 2100 PENNSYLVANIA AVENUE, N.W., SUITE 800, WASHINGTON, DC, 20037, US

(21) Appl. No.: 10/530,885

(22) PCT Filed: Oct. 14, 2003
(86) PCT No.: PCT/JP03/13114

§ 371 Date: Apr. 11, 2005

(30) Foreign Application Priority Data
Oct. 11, 2002 (JP) 2002-298895

(51) Int. Cl. C08K 3/18

(52) U.S. Cl. 524/430

(57) ABSTRACT

A cationic polymerization type composition includes (A) component: a monofunctional oxetane compound containing one oxetanyl group in the molecule thereof, (B) component: a compound containing two or more cationic ring-opening polymerizable cycle ether residues in the molecule thereof, (C) component: a cationic polymerization initiator having latency, and (D) component: a metal oxide fine particle having a particle size of from 1 to 1,000 nm. The cationic polymerization type composition exhibits good curing properties upon irradiation with active energy rays in air to form a coating film low in residual stress in a cured film and excellent in adhesion, and can impart characteristics such as high surface hardness, abrasion resistance, ultraviolet light shielding properties, heat ray shielding properties, electrical conductivity, and antifungal properties by stably dispersing the component (D).

### TECHNICAL FIELD

The present invention relates a curable resin composition which is useful as a coating material or a coating agent, etc. More particularly, the invention relates to a curable resin composition which can be cured within a short period of time upon irradiation with light or heating, thereby forming a coating film having excellent transparency, reduces a residual stress that imparts adverse influences such as warpage to a substrate such as plastics and metals, is excellent in adhesion, can impart characteristics such as high surface hardness, abrasion resistance, ultraviolet light shielding properties, heat ray shielding properties, electrical conductivity, and antifungal properties by choosing a metal oxide fine particle, and can adjust a refractive index of a film to be formed.

### BACKGROUND ART

In the field of curing initiated with ultraviolet light (UV), photo-initiated radical polymerization using a polyfunctional acrylate, an unsaturated polyester, etc. is widely studied and is industrially applied in a number of fields including coating materials, inks, adhesives, coating agents, photo shaping, and resist inks. However, since the radical polymerization is inhibited by oxygen in air, curing of the surface layer is slow so that there are involved such defects that the surface is stained in the post step and that the surface is likely scratched. Especially, in the case of a thin film of not more than 2 to 3 μm which is used in spray coating or gravure printing, etc., an influence of oxygen inhibition is so large that there is encountered such a problem that curing hardly takes place in air. Also, a radical polymerization type active energy ray curable resin is large in curing shrinkage so that it involves such a problem that its adhesion to a substrate is inferior.

In contrast, since photo-initiated cationic polymerization differs from the foregoing photo-initiated radical polymerization and is not subject to polymerization inhibition by oxygen, it is possible to undergo the polymerization completely in air. Also, in the case where an epoxide that is a ring-opening polymerizable monomer is used, since it is low in curing shrinkage, it has excellent adhesion to a substrate and at the same time, can provide cured materials having good heat resistance and chemical resistance. However, since a photocationic curing type epoxy compound is relatively slow with respect to the photopolymerization rate of an epoxy group, it was hardly said that this compound is suitable for applications in which rapid photocuring properties are required. That is, there are involved such problems that the curing rate is slow and that the surface of a coating film is likely scratched (for example, see JP-A-6-228413).

On the other hand, it is reported that the cationic polymerization rate of an oxetanyl group is in general largely accelerated by blending an epoxy compound, thereby exhibiting rapid curing (for example, see JP-A-7-053711 and JP-A-7-062082). Also, it is disclosed to apply an oxetanyl group-containing compound as a monomer of photo-initiated cationic polymerization (for example, see JP-A-6-016804). However, it was reported that a cured film of a composition composed of the foregoing oxetane compound and an alicyclic epoxy compound is in general low in adhesion to a substrate (see Polymer Frontier 21 Series, edited by The Society of Polymer Science, 2001, Vol. 6, pages 77 to 101).

It is disclosed that a photocurable composition comprising 3-ethyl-3-phenoxymethyloxetane containing one aromatic ring and one oxetanyl group in one molecule having an epoxy compound blended therewith has low viscosity and excellent curing properties and is excellent in strength and elongation of a cured material (for example, see JP-A-11-140279). Also, it is reported by the subject inventor that a similar composition forms a film having excellent adhesion and that a mechanism for revealing the adhesion is caused by stress relaxation at the time of curing (see H. Sasaki, Rad Tech North America, 2002, pages 64 to 78).

On the other hand, there are reported studies in which an inorganic material such as a metal oxide fine particle is added to such an organic curing type material, thereby adding various functions to a coating film to be formed (for example, see Engineering System for Fine Particles, Applied Technology II, Fujitec Corporation, 2002, pages 275 to 285 and Development and Application of Inorganic/Organic Hybrid Materials, CMC Publishing Co., Ltd., 2000, pages 54 to 73).

With respect to a combination of a photocuring type material and a finely particulate inorganic material, there is reported a transparent material composed of a resin obtained from an organic silane compound and/or an hydrolyzate thereof as a vehicle and a finely particulate inorganic material having a mean particle size of from 1 to 300 nm, wherein the subject finely particulate inorganic material is contained in an amount of from 5 to 80% by weight in the transparent material (for example, see JP-B-3-2459). In this material, since its curing depends upon dehydration shrinkage due to heating of the organic silane compound or the like, the reaction is slow so that it takes several hours to several tens hours until completion of the curing. Also, a change in a rate of shrinkage before and after heat curing is remarkable, and its film forming properties are poor. Accordingly, it was difficult to make the thickness of a material of coating thick.

The following are reported as ones capable of improving such defects.

A curable metal oxide particle made of colloidal silica having been modified with methacryloxysilane is disclosed, and it is proposed to mix the subject curable metal oxide particle with an acrylate resin and use the mixture as a photocuring type coating material (for example, see JP-B-62-21815). However, a composition capable of providing a cured film having excellent adhesion and surface strength could not be obtained.

As a liquid curable resin composition for providing cured materials having transparency, high refractive index, high hardness and abrasion resistance, which can be especially suitably used as a coating material, there is reported a liquid curable resin composition containing a radiation polymerization initiator as well as a reaction product obtained by reacting a polyfunctional (meth)acrylic compound containing at least three (meth)acryloyl groups in the molecule thereof, a compound containing a polymerizable unsaturated group and an alkoxysilane group in the molecule thereof, and a particle of an oxide of a metal selected from group consisting of zirconium, antimony, zinc, tin, cerium, and titanium (for example, see JP-A-2000-143924).

Since all of them use a radical polymerizable material, the foregoing problems including failure of curing of a thin film and failure of adhesion to a substrate due to curing shrinkage still remained.

Also, it is reported to use, as a binder, a radiation curable monomer whose hardness after curing has been improved by incorporating colloidal silica as surface treated with an organosilicon compound (for example, see JP-A-8-217991).

However, in the disclosed technologies, ones which are used as a polymerization type material are concerned only with a radical polymerization type material, and it is hardly said that the hardness of a film to be formed is sufficient. From these disclosed technologies, a composition having an excellent curing rate in air and capable of providing a cured film having excellent adhesion and surface hardness could not be obtained.

A curable composition having blended therewith a metal oxide particle which has been reacted with a hydrolyzable group-containing oxetane compound is reported, and this has storage stability and is excellent in curing performance in a composition having this metal oxide particle blended therewith (for example, see JP-A-2000-26730). However, this metal oxide particle is different from a metal oxide fine particle of this application, and properties of the composition after curing are different.

Though it is recognized that there is a report regarding the matter that the hardness after curing of a cationic polymerizable composition is improved by incorporating a surface-treated metal oxide particle, this was not concerned with the matter that the hardness after curing is improved by incorporating a non-surface-treated metal oxide particle.

### DISCLOSURE OF THE INVENTION

An object of the invention is to overcome the foregoing problems of the conventional technologies and to provide a cationic polymerization type composition which is rapidly cured in air, is good in film forming properties, can be made thick in thickness, is excellent in transparency of a film after curing, reduces a residual stress at the time of curing, has high adhesion, and can impart characteristics such as high surface hardness, abrasion resistance, ultraviolet light shielding properties, heat ray shielding properties, electrical conductivity, and antifungal properties.

For the sake of solving the foregoing problems, the present inventors made extensive and intensive investigations. As a result, it has been found that a cationic polymerization type composition comprising (A) component: a monofunctional oxetane compound containing one oxetanyl group in the molecule thereof, (B) component: a compound containing two or more cationic ring-opening polymerizable cyclic ether residues in the molecule thereof, (C) component: a cationic polymerization initiator having latency, and (D) component: a metal oxide fine particle having a particle size of from 1 to 1,000 nm exhibits good curing properties upon irradiation with active energy rays in air; that the resulting coating film is low in residual stress in a cured film and excellent in adhesion; and that the component (D) is stably dispersed, whereby characteristics such as high surface hardness, abrasion resistance, ultraviolet light shielding properties, heat ray shielding properties, electrical conductivity, and antifungal properties can be imparted, leading to accomplishment of the invention.
1. A cationic polymerization type composition comprising (A) component: a monofunctional oxetane compound containing one oxetanyl group in the molecule thereof, (B) component: a compound containing two or more cationic ring-opening polymerizable cyclic ether residues in the molecule thereof, (C) component: a cationic polymerization initiator having latency, and (D) component: a metal oxide fine particle having a particle size of from 1 to 1,000 nm.
2. The cationic polymerization type composition as set forth above in the item 1, wherein the component (D) is at least one member selected from silica, titanium oxide, aluminum oxide, zirconia oxide, zinc oxide, cerium oxide, antimony oxide, tin oxide, and antimony-doped tin oxide.
3. The cationic polymerization type composition as set forth above in the item 1, wherein the component (D) is silica, titanium oxide, aluminum oxide, zinc oxide, or tin oxide.
4. The cationic polymerization type composition as set forth above in the item 1, wherein the component (D) is silica.
5. The cationic polymerization type composition as set forth above in any of the items 1 to 4, wherein the component (A) is blended in an amount of from 10 to 80 parts by mass based on 100 parts by mass of the total sum of the polymerizable material comprising the component (A) and the component (B).
6. The cationic polymerization type composition as set forth above in any of the items 1 to 5, wherein at least a part of the component (A) is a monofunctional oxetane compound containing an aromatic in the molecule thereof.
7. The cationic polymerization type composition as set forth above in any of the items 1 to 6, wherein at least a part of the component (B) is an epoxy compound containing two or more glycidyl ether residues and aromatics in the molecule thereof.
8. The cationic polymerization type composition as set forth above in any of the items 1 to 7, wherein at least a part of the component (B) is an epoxy compound containing two or more glycidyl ether residues in the molecule thereof, which is selected from a substituted or unsubstituted bisphenol resin glycidyl ether, a substituted or unsubstituted novolak resin glycidyl ether, a substituted or unsubstituted biphenol resin glycidyl ether, and a substituted or unsubstituted naphthalene resin glycidyl ether.
9. The cationic polymerization type composition as set forth above in any of the items 1 to 8, wherein the component (C) is an onium salt having light latency.
10. The cationic polymerization type composition as set forth above in any of the items 1 to 9, wherein the component (C) is an onium salt containing, as an anion residue, one member selected from SbF₆⁻, AsF₆⁻, and B(C₆F₅)₄⁻.
11. The cationic polymerization type composition as set forth above in any of the items 1 to 10, wherein an organosilicon compound is added as a component (E).
12. The cationic polymerization type composition as set forth above in any of the items 1 to 11, wherein the organosilicon compound to be used as the component (E) contains a cationic polymerizable group.

### BEST MODE FOR CARRYING OUT THE INVENTION

The invention will be hereunder described in detail.

Component (A)

In the invention, the component (A) is a monofunctional oxetane compound containing one oxetanyl group in the molecule thereof, and examples thereof include an oxetane compound represented by the following general formula (1).

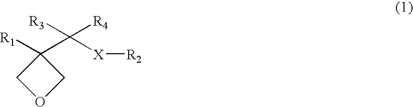

In the formula (1), R₁ represents a hydrogen atom or a linear or branched alkyl group having from 1 to 4 carbon atoms; R₂ represents a linear or branched alkyl group having from 1 to 8 carbon atoms, which may contain a halogen group and/or an alkyl group having from 1 to 4 carbon atoms, a phenyl group or a naphthyl group, each of which may contain a halogen group, or a cycloalkyl group having from 4 to 7 carbon atoms, which may contain a halogen group; R₃ and R₄ each represents a hydrogen atom or a linear or branched alkyl group having from 1 to 4 carbon atoms; and X represents an oxygen atom.

As R₁ in the formula (1), a linear or branched alkyl group having from 1 to 4 carbon atoms is preferable; a methyl or an ethyl group is more preferable; and an ethyl group is especially preferable.

As R₂ in the formula (1), a linear or branched alkyl group having from 1 to 8 carbon atoms, a phenyl group or a naphthyl group, each of which may contain a halogen group and/or an alkyl group having from 1 to 4 carbon atoms, or a cycloalkyl group having from 4 to 7 carbon atoms is preferable; a linear or branched alkyl group having from 1 to 8 carbon atoms, or a phenyl group or a naphthyl group, each of which may contain a halogen group and/or an alkyl group having from 1 to 4 carbon atoms, is more preferable; and a phenyl group is especially preferable.

As R₃ and R₄ in the formula (1), a hydrogen atom or a linear alkyl group having from 1 to 4 carbon atoms is preferable; and a hydrogen atom is more preferable.

Examples of the formula (1) include 3-ethyl-3-(phenoxymethyl)oxetane, 3-ethyl-3-(hexyloxymethyl)oxetane, 3-ethyl-3-(2-ethylhexyloxymethyl)oxetane, and 3-ethyl-3-(chloromethyl)oxetane. Of these, 3-ethyl-3-(phenoxymethyl)oxetane (OXT-211 (a trade name), manufactured by TOAGOSEI CO., LTD.) which is a derivative containing an aromatic group in the molecule thereof is preferable.

The component (A) is preferably blended in an amount of from 10 to 80 parts by mass, more preferably from 20 to 70 parts by mass, and especially preferably from 30 to 60 parts by mass based on 100 parts by mass of the total sum of the polymerizable material comprising the component (A) and the component (B).

Component (B)

In the invention, the component (B) is a compound containing two or more ring-opening polymerizable cyclic ether groups in the molecule thereof, and examples thereof include an epoxy compound, an oxetane compound, an oxolane compound, a cyclic acetal compound, and a spiro ortho ester compound which is a reaction product of an epoxy compound and a lactone. These compounds can be used singly or in combinations of two or more kinds thereof.

Examples of the epoxy compound include bisphenol A diglycidyl ether, bisphenol F diglycidyl ether, bisphenol S diglycidyl ether, brominated bisphenol A diglycidyl ether, brominated bisphenol F diglycidyl ether, brominated bisphenol S diglycidyl ether, an epoxy novolak resin, hydrogenated bisphenol A diglycidyl ether, hydrogenated bisphenol F diglycidyl ether, hydrogenated bisphenol S diglycidyl ether, 3,4-epoxycyclohexylmethyl-3′,4′-epoxycyclohexanecarboxylate, 2-(3,4-epoxycyclohexyl-5,5-spiro-3,4-epoxy)cyclohexane-meta-dioxane, bis(3,4-epoxycyclohexylmethyl)adipate, vinylcyclohexene oxide, 4-vinylepoxycyclohexane, bis(3,4-epoxy-6-methylcyclohexyl-methyl)adipate, 3,4-epoxy-6-methylcyclohexyl-3′,4′-epoxy-6′-methylcyclohexanecarboxylate, methylenebis(3,4-epoxycyclohexane), dicyclopentadienediepoxide, di(3,4-epoxycyclohexylmethyl)ether of ethylene glycol, ethylenebis(3,4-epoxycyclohexanecarboxylate), 1,4-butanediol diglycidyl ether, 1,6-hexanediol diglycidyl ether, glycerin triglycidyl ether, trimethylolpropane triglycidyl ether, polyethylene glycol diglycidyl ether, and polypropylene glycol diglycidyl ether. Further, there can be enumerated polyglycidyl ethers of a polyether polyol obtained by adding one or two or more alkylene oxides to an aliphatic polyhydric alcohol such as ethylene glycol, propylene glycol, and glycerin; diglycidyl esters of an aliphatic long-chain dibasic acid; monoglycidyl ethers of an aliphatic higher alcohol; monoglycidyl ethers of a polyether alcohol obtained by adding an alkylene oxide to phenol, cresol, butylphenol, or a mixture thereof; glycidyl esters of a higher fatty acid; epoxidized soy bean oil; butyl epoxystearate; octyl epoxystearate; epoxidized linseed oil; and epoxidized polybutadiene.

As the oxetane compound, any compound can be used without particular limitations so far as it contains two or more oxetane rings in the molecule thereof. Concretely, various oxetane compounds described in JP-A-8-85775 and JP-A-8-134405 and the like are enumerated. Examples of the bifunctional oxetane include 1,4-bis[(3-ethyl-3-oxetanylmethoxy)methyl]benzene and bis{[1-ethyl(3-oxetanyl)]methyl}ether. Examples of these compounds include ARON OXETANE OXT-121 AND OXT-221 (all of which are a trade name), manufactured by TOAGOSEI CO., LTD.

As the component (B) containing two or more cationic ring-opening polymerizable cyclic ether residues in the molecule thereof, epoxy compounds containing two or more glycidyl ether residues and aromatic groups in the molecule thereof are preferable. Specific examples thereof include a substituted or unsubstituted bisphenol resin glycidyl ether, a substituted or unsubstituted novolak resin glycidyl ether, and a substituted or unsubstituted biphenol resin glycidyl ether.

At least one compound selected from the foregoing epoxy compounds containing two or more glycidyl ether residues and aromatic groups in the molecule thereof is preferably blended in an amount of from 10 to 100% by mass, and more preferably from 50 to 100% by mass in the component (B).

Component (C)

In the invention, the component (C) is a cationic polymerization initiator having latency and generates an activated acid component by application of active energy rays or heat, thereby acting to induce cationic ring-opening polymerization of the ring-opening polymerizable group in the composition.

As the cationic polymerization initiator having latency against light among active energy rays, arbitrary photocationic polymerization initiators can be used so far as they can induce ring opening of the ring-opening polymerizable group having been activated upon irradiation with light. Examples of the photocationic polymerization initiator include onium salts and organic metal complexes. Examples of the onium salts include diazonium salts, sulfonium salts, and iodonium salts. Also, examples of the organic metal complexes include iron-allene complexes, titanocene complexes, and aryl silanol-aluminum complexes.

As the cationic polymerization initiator having thermal latency, arbitrary thermal cationic polymerization initiators are used so far as they are activated by heating, thereby inducing ring opening of the ring-opening polymerizable group. Examples thereof include organic metal complexes as well as various onium salts such as quaternary ammonium salts, phosphonium salts, and sulfonium salts.

As the component (C), ones containing, as an anion residue, one member selected from SbF₆⁻, AsF₆⁻, and B(C₆F₅)₄⁻ are preferable.

Specifically, ones having light latency such as ADEKA OPTOMER SP-170 and ADEKA OPTOMER SP-150 (all of which are a trade name, manufactured by ASAHI DENKA CO., LTD.), UV9380C (a trade name, manufactured by GE TOSHIBA SILICONES), and RHODOSIL 2074 (a trade name, manufactured by RHODIA); and ones having thermal latency such as ADEKA OPTON CP-66 and ADEKA OPTON CP-77 (all of which are a trade name, manufactured by ASAHI DENKA CO., LTD.) and SAN-AID SI-60L, SAN-AID SI-80L and SAN-AID SI-100L (all of which are a trade name, manufactured by SANSHIN CHEMICAL INDUSTRY CO., LTD.) can be applied as the component (C).

A blending proportion of the component (C) is preferably from 0.01 to 5 parts by mass, and more preferably from 0.1 to 4 parts by mass based on 100 parts by mass of the total sum of the polymerizable material comprising the component (A) and the component (B). In the case where the blending proportion of the latent cationic polymerization initiator is less than 0.01 parts by mass, even when activated by the action of light or heat, it may be impossible to advance the ring-opening reaction of the ring-opening polymerizable group sufficiently, whereby the heat resistance and water absorption rate after polymerization may possibly become insufficient. Also, even when the latent cationic polymerization initiator is blended in a proportion exceeding 5 parts by mass, the action to advance the polymerization does not, increase any more, and inversely, other characteristics such as heat resistance may possibly be lowered.

Component (D): Metal Oxide Fine Particle

In the invention, the kind of the metal oxide fine particle to be used as the component (D) is not particularly limited, but examples thereof include particles of silica (silicon dioxide), titanium oxide, aluminum oxide, zirconia oxide, zinc oxide, cerium oxide, antimony oxide, antimony-doped tin oxide, and tin oxide. More preferably, there are enumerated silica, titanium oxide, aluminum oxide, zinc oxide, and tin oxide. These particles can be used singly or in combinations of two or more kinds thereof.

Incidentally, silica is further preferable as the metal oxide fine particle. The silica may be a particle containing silica as the major component and may contain other components than silica. Examples of such other components than silica include alkali metal oxides, alkaline earth oxides, titanium oxide, aluminum oxide, zirconia oxide, zinc oxide, cerium oxide, boron oxide, tin oxide, and phosphorus oxide.

A blending amount of the component (D) is preferably from 1 to 500 parts by mass, more preferably from 10 to 300 parts by mass, and especially preferably from 30 to 200 parts by mass based on 100 parts by mass of the total sum of the polymerizable material comprising the components (A) and (B). In the case where the blending amount is not more than 1 part by mass, modification of a cured film due to the addition of the metal oxide fine particle is not sufficient; and in the case where it exceeds 500 parts by mass, dispersion becomes difficult so that a uniform film is hardly obtained.

Though the mean particle size (particle size) of the component (D) can be enumerated to be from 1 to 1,000 nm, it is preferably from 1 to 500 nm, more preferably from 2 to 200 nm, especially preferably from 2 to 50 nm, and further especially preferably 5 to 50 nm. When the particle size of the particle is less than 1 nm, handling and mixing and dispersion tend to become difficult; and on the other hand, when it exceeds 1,000 nm, in the case where the component (D) is mixed and dispersed in the resin, it is liable to cause sedimentation, or transparency of the resin tends to be lowered.

When the particle size of the component (D) exceeds 10 μm, curing due to active energy rays, especially light such as ultraviolet light tends to become difficult.

A specific surface area of the component (D) is preferably a value in the range of from 0.1 to 3,000 m²/g, and more preferably from 10 to 1,500 m²/g. When the specific surface area of the particle is less than 0.1 m²/g, in the case where the component (D) is mixed and dispersed in the resin, it is liable to cause sedimentation, or transparency of the resin tends to be lowered. On the other hand, when the specific surface area of the particle exceeds 3,000 m²/g, handling and mixing and dispersion tend to become difficult.

Further, though the shape of the particle of the component (D) is not particularly limited, it is preferably at least one shape selected from the group of spherical, hollow, porous, rod-like, tabular, fibrous, and amorphous shapes. However, it is more preferred to use a spherical particle from the viewpoint of better dispersibility.

Also, though the use state of the particle of the component (D) is not particularly limited, for example, the particle of the component (D) can be used in the dried state or can be used in the state that it is dispersed in water or an organic solvent. Also, a liquid in the state that a finely particulate silica particle is dispersed using a dispersing solvent can be used, and such is preferable especially for the purpose of pursuing transparency.

Here, in the case where the dispersing solvent is an organic solvent, methanol, isopropyl alcohol, ethylene glycol, butanol, ethylene glycol monopropyl ether, methyl ethyl ketone, methyl isobutyl ketone, toluene, xylene, dimethylformamide, and the like can be used. Incidentally, methyl ethyl ketone, methyl isobutyl ketone, xylene, and the like are more preferable as the dispersing solvent. Also, these organic solvents may be used as a mixture with an organic solvent which is compatible with the former organic solvents or water.

Component (E): Organosilicon Compound

In the invention, if desired, an organic silane compound and an organosilicon compound which is a hydrolyzate of the former represented by the following formula (2) can be used as the component (E).
(R₅)ₙ—Si—(Y)₄₋ₙ (2)

In the formula (2), R₅ represents an organic group having from 1 to 12 carbon atoms, which is bonded to silicon via an Si—C bond; Y represents a hydrolyzable group; and n represents an integer of from 0 to 3.

The organic group R₅ in the general formula (2) can be selected among monovalent organic groups having from 1 to 12 carbon atoms, each of which is bonded to silicon via an Si—C bond. As such an organic group, a non-polymerizable organic group and a polymerizable organic group, or either one of these organic groups can be selected.

Examples of the organic group R₅ in the formula (2) include an alkyl group, an aryl group, and an aralkyl group. These groups may be linear, branched or cyclic or may be a combination thereof.

More specific examples of the alkyl group of the organic group R₅ in the formula (2) include a methyl group, an ethyl group, a propyl group, a butyl group, a hexyl group, a cyclohexyl group, an octyl group, and a halogenated alkyl group. Of these alkyl groups, a methyl group is more preferable. Also, specific examples of the aryl group in the non-polymerizable organic group R₅ include a phenyl group, a tolyl group, a xylyl group, a naphthyl group, a biphenyl group, and a halogenated aryl group. Of these, a phenyl group is more preferable.

Also, the non-polymerizable organic group R₅ in the formula (2) can be made of a structural unit containing a hetero atom. Examples of such a structural unit include an ether bond and an ester bond. Also, in the case of containing a hetero atom, it is preferable that the structural unit is non-basic.

Also, the polymerizable organic group R₅ in the formula (2) is preferably an organic group containing a cationic polymerizable functional group in the molecule thereof. By incorporating such a functional group to employ cationic polymerization in combination, the photopolymerizable resin composition can be cured more effectively, thereby bringing an effect for increasing the strength and hardness of the material after curing. Examples of the organic group R₅ containing a cationic polymerizable functional group include organic groups having a cyclic ether structure. Examples of such a cyclic ether group include groups containing a 3-membered to 6-membered cyclic ether structure having a linear or cyclic structure, more specifically a glycidyl group, an oxetanyl group, a group having a tetrahydrofuran structure, and a group having a pyran structure.

Of these cyclic ether groups, cyclic ether structures made of not more than four members, such as a glycidyl group and an oxetanyl group, are more preferable. Also, specific examples of the organic group having a cyclic ether structure include a glycidylpropyl group, a 2-(3,4-epoxycyclohexyl)ethyl group, a methyloxetanylmethoxypropyl group, and an ethyloxetanylmethoxypropyl group.

Next, specific contents of the hydrolyzable group Y in the general formula (2) will be hereunder described. In the invention, the hydrolyzable group Y is preferably an alkoxy group having from 1 to 12 carbon atoms.

Preferred examples of the alkoxy group having from 1 to 12 carbon atoms in Y of the formula (2) include a methoxy group, an ethoxy group, a propoxy group, a butoxy group, a phenoxybenzyloxy group, a methoxyethoxy group, an acetoxyethoxy group, an epoxy group-containing alkoxy group such as a glycidyloxy group and a 2-(3,4-epoxycyclohexyl)ethoxy group, and an oxetanyl group-containing alkoxy group such as a methyloxetanylmethoxy group and an ethyloxetanylmethoxy group.

In the case where the component (E) is blended in the active energy ray-curable cationic polymerization type composition, the component (E) is preferably used in an amount of not more than 75 parts by mass, and more preferably not more than 50 parts by mass based on 100 parts by mass of the metal oxide fine particle as the component (D). When the amount of the component (E) exceeds 75 parts by mass, there may possibly be caused problems including not only a lowering of the strength of a film but also a lowering of the optical properties and an increase of the costs.

Incidentally, the component (E) is used mainly for a surface treatment of the component (D).

Organic Solvent

In the composition of the invention, if desired, an organic solvent can be blended. Though such an organic solvent can be chosen within the range where the purpose and effect of the invention are not hindered, it is usually an organic compound having a boiling point value in the range of from 50 to 200° C. under atmospheric pressure and is preferably an organic compound which uniformly dissolves therein the respective components. Preferred examples of the organic solvent include alcohols such as methanol, ethanol, propanol, and butanol; ethers such as dibutyl ether, ethylene glycol dimethyl ether, tetrahydrofuran, and dioxane; ketones such as acetone, methyl ethyl ketone, methyl isobutyl ketone, and cyclohexanone; esters such as ethyl acetate, butyl acetate, amyl acetate, and γ-butyrolactone; and aromatic hydrocarbons such as benzene, toluene, and xylene. They can be used singly or in combinations of two or more kinds thereof.

Of these, more preferred examples of the organic solvent include alcohols, ethers, and ketones, with alcohols and ketones being further preferred.

Other Arbitrary Components

In the cationic polymerization type composition of the invention, the following components can be added and blended, if desired.

Examples of arbitrary components which can be blended in the cationic polymerization type composition of the invention include powdered reinforcing agents and fillers, for example, metal carbonates such as calcium carbonate and magnesium carbonate, kaolin, mica, quartz powder, graphite, and molybdenum disulfide; and fibrous reinforcing agents and fillers, for example, glass fibers, ceramic fibers, carbon fibers, alumina fibers, silicon carbide fibers, boron fibers, polyester fibers, and polyamide fibers. They are preferably blended in an amount of not more than 900 parts by mass, more preferably not more than 700 parts by mass, and especially preferably not more than 300 parts by mass based on 100 parts by mass of the composition of the invention.

Further, as arbitrary components which can be blended in the cationic polymerization type composition of the invention, coloring agents, pigments, and flame retarders, for example, titanium dioxide, black iron oxide, molybdenate orange, Berlin blue, Prussian blue, cadmium yellow, cadmium red, antimony trioxide, red phosphorus, bromide compounds, triphenyl phosphate, and the like can be blended. They are preferably blended in an amount of not more than 20 parts by mass, more preferably not more than 15 parts by mass, and especially preferably not more than 5 parts by mass based on 100 parts by mass of the composition of the invention.

Further, as arbitrary components which can be blended in the cationic polymerization type composition of the invention, various curable monomers, oligomers, and synthetic resins can be blended for the purpose of improving the properties of resins in ultimate adhesive layers, molded articles, etc. For example, one kind or a combination of two or more kinds of diluents for epoxy resins such as monoepoxys, phenol resins, alkyd resins, melamine resins, fluorine resins, vinyl chloride resins, acrylic resins, silicone resins, polyester resins, and the like can be enumerated. A blending proportion of such a resin is an amount falling within the range where original properties of the resin composition of the invention are not hindered, that is, preferably not more than 50 parts by mass, more preferably not more than 30 parts by mass, and especially preferably not more than 10 parts by mass based on 100 parts by mass of the composition of the invention.

Examples of blending means of the respective components and arbitrary components in the composition of the invention include hot melt mixing, melt kneading by a roll or a kneader, wet mixing using an appropriate organic solvent, and dry mixing.

Curing Method

In the cationic polymerization type composition of the invention, in the case where curing is carried out upon irradiation with active energy rays, especially light, a light source which can be used is not particularly limited. Examples thereof include ones having a light emission distribution at a wavelength of not more than 400 nm, such as a low pressure mercury vapor lamp, a medium pressure mercury vapor lamp, a high pressure mercury vapor lamp, an ultra-high pressure mercury vapor lamp, a chemical lamp, a black light lamp, a microwave-excited mercury vapor lamp, and a metal halide lamp. A light irradiation intensity against the composition should be controlled for every targeted product and is not particularly limited. However, the light irradiation intensity in a light wavelength region effective for activating the photocationic polymerization initiator (light of from 250 to 420 nm is usually used though it varies depending upon the photopolymerization initiator) is preferably from 0.1 to 100 mW/cm². When the light irradiation intensity against the composition is less than 0.1 mW/cm², the reaction time becomes excessively long. On the other hand, when it exceeds 100 mW/cm², yellowing of the resulting cured material or deterioration of the support may possibly be caused due to heat radiated from the amp and heat generation at the time of polymerization of the composition.

The light irradiation time against the composition should be controlled for every targeted product and is not particularly limited. However, it is preferable that an accumulated quantity of light represented by the product of the light irradiation intensity and the light irradiation time in the foregoing light wavelength region is set up at from 10 to 5,000 mJ/cm². When the accumulated quantity of light against the composition is less than 10 mJ/cm², the generation of an active species from the photocationic polymerization initiator is not sufficient so that the hardness and heat resistance of the resulting cured material may possibly be lowered. On the other hand, when it exceeds 5,000 mJ/cm², the irradiation time becomes very long, resulting in a disadvantage for the purpose of improving the productivity.

Also, in the case where the polymerization is carried out by heat, the heat can be applied by generally known methods, and conditions thereof and the like are not particularly limited.

### EXAMPLES

The invention will be hereunder described in more detail with reference to the Examples and Comparative Examples. Incidentally, all parts used in the respective Examples mean parts by mass.

### Examples 1 to 3 and Comparative Examples 1 and 2

3-Ethyl-3-(phenoxymethyl)oxetane (OXT-211 (a trade name), manufactured by TOAGOSEI CO., LTD.) as the component (A), bisphenol A diglycidyl ether (BADGE, a trade name: EPIKOTE 828, manufactured by JAPAN EPOXY RESINS CO., LTD.) as the component (B), tetraallylsulfonium hexafluorophosphate which is an onium salt having light latency (SP-170, a trade name: OPTOMER SP-170, manufactured by ASAHI DENKA CO., LTD.) as the component (C), colloidal silica dispersed in methyl ethyl ketone (MEK-ST (a trade name, manufactured by NISSAN CHEMICAL INDUSTRIES, LTD.), solids content=30 wt %, organic solvent=methyl ethyl ketone, silica particle size=about 10 to 20 nm) as the component (D), and methyl ethyl ketone were thoroughly stirred and mixed at room temperature in a blending ratio (by mass) as shown in Table 1 such that the mixture became uniform. There were thus obtained curable compositions of Examples 1 to 3 and Comparative Examples 1 and 2.

Incidentally, the component (C) was added in an amount of 2 parts by mass based on 100 parts by mass of the polymerizable components.

And the addition amount of the methyl ethyl ketone was adjusted such that the total sum of the polymerizable components and the component (D) (metal oxide fine particle) became 250 parts by mass.

The foregoing composition was coated on a polyethylene terephthalate (PET) film or a methacrylic resin (PMMA) plate using a #30 bar coater and kept at 80° C. for 10 minutes, thereby removing the solvent. Thereafter, irradiation with ultraviolet light was carried out twice at a conveyer speed of 10 m/sec using a 120 W/cm high pressure mercury vapor lamp (lamp height: 10 cm), thereby undergoing photocuring, and the cured material was then subjected to post curing in an oven at 100° C. for one hour (film thickness: about 10 μm).

Evaluation results of adhesion, pencil hardness, the presence or absence of film curling, scratch resistance, and Taber abrasion, etc. of Examples 1 to 3 and Comparative Examples 1 and 2 are shown in Table 1, and microhardness measurement results are shown in Table 2. PMMA of Table 2 means measurement results regarding only the methacrylic resin plate.

Incidentally, the evaluation was carried out according to the following methods.
Adhesion: The evaluation of adhesion of a cured coating film was carried out by a cross-cut adhesion test according to JIS K-5400.

◯: Not peeled.

Δ: Slightly peeled.

X: Entirely peeled.
Pencil hardness: The pencil harness measurement of a cured coating film was carried out according to JIS D-0202.

Film curling: On a 10-cm square PET film having a thickness of 50 μm, each composition was coated, dried and cured, and then evaluated with respect to its appearance.

◯: Curling did not occur at all.

Δ: Curling occurred.

X: Curling largely occurred.
Scratch resistance: A #0000 steel wool was reciprocated 30 times on the surface of a cured material under a load of 500 g, and scratching of the surface was visually evaluated.

◯: Not scratched.

Δ: Slightly scratched.

X: Scratched.
Taber abrasion test: Using CS-10F as an abrasion wheel, abrasion was carried out 500 times under a load of 500 g according to a Taber abrasion test, and a change of haze before and after the test (ΔHaze (%)) was evaluated.

Microhardness measurement: A cured coating film was measured with respect to universal hardness (N/mm²), Young's modulus (MPa) and plastic deformation hardness (N/mm²) using Fischerscope H100V, manufactured by FISCHER.

TABLE 1

| | | | | | Comparative | Comparative |
|---|---|---|---|---|---|---|
| | | Example 1 | Example 2 | Example 3 | Example 1 | Example 2 |
| OXT-211 | | 35 | 27.5 | 20 | — | 50 |
| BADGE | | 35 | 27.5 | 20 | 100 | 50 |
| SP-170 | | 1.4 | 1.1 | 0.8 | 2 | 2 |
| MEK-ST | | 100 | 150 | 200 | — | — |
| Methyl ethyl ketone | | 80 | 45 | 10 | 150 | 150 |
| Content of metal oxide | | 30 | 45 | 60 | 0 | 0 |
| fine particle (wt %) | | | | | | |
| Presence or absence of | | ∘ | ∘ | ∘ | x | Δ |
| curling | | | | | | |
| Pencil | PMMA | 4H | 4H | 4H | H | H |
| hardness | PET | H | H | H | HB | HB |
| Adhesion | PMMA | ∘ | ∘ | ∘ | x | ∘ |
| | PET | ∘ | ∘ | ∘ | x | ∘ |

| | | | | | |
|---|---|---|---|---|---|
| Scratch resistance | ∘ | ∘ | ∘ | x | x |
| Taber abrasion (ΔHaze %) | 27.5 | 23.7 | 17.1 | 58.1 | 55.7 |

TABLE 2

| | | | Plastic |
|---|---|---|---|
| | Universal | Young's | deformation |
| | hardness | Modulus | hardness |
| | (HU: N/mm²) | (MPa) | (HUpl: N/mm²) |
| Example 1 | 256 | 5900 | 384 |
| Example 2 | 316 | 7015 | 491 |
| Example 3 | 427 | 9325 | 682 |
| Comparative | 196 | 4261 | 308 |
| Example 2 | | | |
| PMMA | 226 | 5148 | 340 |

As is clear from the results of Tables 1 and 2, the cured materials made of the metal oxide fine particle-containing cationic polymerization type composition of the invention are excellent in hardness, adhesion, scratch resistance and abrasion resistance as compared with those not containing a metal oxide fine particle. It is considered that this improvement of the performance is largely influenced by the particle size of the metal oxide fine particle.

### INDUSTRIAL APPLICABILITY

The composition as disclosed in the invention can be cured within a short period of time upon irradiation with light or heating, thereby forming a coating film having excellent transparency, reduces a residual stress that imparts adverse influences such as warpage to a substrate such as plastics and metals, is excellent in adhesion, can impart characteristics such as high surface hardness, abrasion resistance, ultraviolet light shielding properties, heat ray shielding properties, electrical conductivity, and antifungal properties by choosing a metal oxide fine particle, and can adjust a refractive index of a film to be formed, and therefore, it can be applied and developed in wide applications. In particular, since the composition of the invention can impart characteristics such as high hardness and abrasion resistance to plastic materials while keeping adhesion in the state that a residual stress is reduced, it can be advantageously used as a coating agent, etc. in applications in the optical, electrical and electronic fields and the like.

1. A cationic polymerization type composition comprising (A) component: a monofunctional oxetane compound containing one oxetanyl group in the molecule thereof, (B) component: a compound containing two or more cationic ring-opening polymerizable cyclic ether residues in the molecule thereof, (C) component: a cationic polymerization initiator having latency, and (D) component: a metal oxide fine particle having a particle size of from 1 to 1,000 nm.

2. The cationic polymerization type composition according to claim 1, wherein the component (D) is at least one member selected from silica, titanium oxide, aluminum oxide, zirconium oxide, zinc oxide, cerium oxide, antimony oxide, tin oxide, and antimony-doped tin oxide.

3. The cationic polymerization type composition according to claim 1, wherein the component (D) is silica, titanium oxide, aluminum oxide, zinc oxide, or tin oxide.

4. The cationic polymerization type composition according to claim 1, wherein the component (D) is silica.

5. The cationic polymerization type composition according to any one of claims 1 to 4, wherein the component (A) is blended in an amount of from 10 to 80 parts by mass based on 100 parts by mass of the total sum of the polymerizable material comprising the component (A) and the component (B).

6. The cationic polymerization type composition according to claim 5, wherein at least a part of the component (A) is a monofunctional oxetane compound containing an aromatic group in the molecule thereof.

7. The cationic polymerization type composition according to claim 5, wherein at least a part of the component (B) is an epoxy compound containing two or more glycidyl ether residues and aromatic groups in the molecule thereof.

8. The cationic polymerization type composition according to claim 7, wherein at least a part of the component (B) is an epoxy compound containing two or more glycidyl ether residues in the molecule thereof, which is selected from a substituted or unsubstituted bisphenol resin glycidyl ether, a substituted or unsubstituted novolak resin glycidyl ether, a substituted or unsubstituted biphenol resin glycidyl ether, and a substituted or unsubstituted naphthalene resin glycidyl ether.

9. The cationic polymerization type composition according to claims 1 to 4, wherein the component (C) is an onium salt having light latency.

10. The cationic polymerization type composition according to claim 9, wherein the component (C) is an onium salt containing, as an anion residue, one member selected from SbF₆⁻, AsF₆⁻, and B(C₆F₅)₄⁻.

11. The cationic polymerization type composition according to claims 1 to 4, wherein an organosilicon compound is added as a component (E).

12. The cationic polymerization type composition according to claim 11, wherein the organosilicon compound to be used as the component (E) contains a cationic polymerizable group.
